(19) United States
(12) Patent Application Publication
(10) Pub. No.: US 2010/0027909 A1
(43) Pub. Date: Feb. 4, 2010

(54) CONVEX OPTIMIZATION APPROACH TO IMAGE DEBLOCKING

(75) Inventors: Oscar Chi Lim Au, Hong Kong (CN); Liwei Guo, Hong Kong (CN)

Correspondence Address: TUROCY & WATSON, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/185,162

(22) Filed: Aug. 4, 2008

(51) Int. Cl. G06K 9/40

(52) U.S. Cl. 382/275

(57) ABSTRACT

Images encoded at low-bit rate may suffer from blocking artifacts, which can dramatically degrade the visual quality of the images. In accordance with the claimed subject matter, a convex optimization approach is provided in order to mitigate such blocking artifacts. Based on the analysis of image coding process as well as natural image properties (e.g., image complexity), a set of constraint functions can be constructed. In addition, an objective function can be constructed based upon, e.g. analysis of a quantization noise model. All functions included in the set as well as the objective function can be convex function. Accordingly, image deblocking can be formulated as a convex optimization problem which can be easily solved using numerical methods. Moreover, the feasibility of the convex optimization problem can be utilized to detect the true object edges and avoid blurring.

### TECHNICAL FIELD

The present disclosure relates generally to image deblocking for decoded images, and more particularly to formulating deblocking of an image in terms of convex optimization that can be readily solved by way of numerical methods.

### BACKGROUND

Block-based transforms followed by scalar quantization is the most popular scheme for image compression. While significantly reducing the number of bits for content representation, this scheme can introduce serious blocking artifacts into the decoded image and degrade the visual quality. It is therefore highly desirable to develop post-processing techniques to mitigate these blocking artifacts in the decoded image.

Conventionally, many different methods have been developed and proposed for image deblocking. Among these known methods, one popular class of post-processing algorithms is based on the notion of projections onto convex sets (POCS). According to these POCS methods, a number of convex constraint sets (described by the corresponding convex functions) have been defined to describe the blocking-free image, while the original image is assumed to be in the intersection of these sets. Thus, in order to achieve deblocking, the decoded image is treated as an initial guess of the original image and is then iteratively projected onto every set. It is expected that the image will converge to one that is free of blocking artifacts with all the constraints satisfied.

While exhibiting varying degrees of deblocking capability, POCS-based approaches have two primary limitations. First, there is no optimization criterion in the deblocking. Rather, the projection iterations will terminate when all the constraints are satisfied, and thus POCS-based approach only solves a feasibility problem. Second, the users have to define the projection operation for every constraint set. However, for some sets, the corresponding projection operations may not be easy to recognize. With improper projection operations, the iteration process may diverge and give an even worse image than before deblocking processes have been initiated.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises an architecture that can provide an optimal solution to an objective function in order to facilitate image deblocking for a decoded image. In accordance therewith and to other related ends, the architecture can receive an image and select a particular section of the image for processing. Based upon examination of the selected image section or the entire image, a set of convex constraint functions can be generated. The set can include one or more convex quantization constraint function as well as one or more convex boundary constraint function.

In more detail, the architecture can examine the image in order to identify or infer/estimate a type of encoding employed. By determining the type of encoding used, one or more convex quantization constraint functions can be constructed. In addition, also based upon image analysis, a level of complexity (e.g., smooth versus textured) for the selected section can be determined. Based upon the level of complexity for the section, one or more convex boundary constraint functions can be derived. For example, low complexity or smooth sections will typically produce boundary constraints that are tighter than higher complexity or textured sections.

Furthermore, the architecture can create a convex objective function. Generally, the objective function will be based upon a quantization noise model and will include both a logarithm-likelihood portion and a summation portion that sums horizontal and vertical gradients over the section. Numerical methods can be employed to optimize the objective function for each pixel included in the selected section while simultaneously satisfying each convex constraint function included in the set. Optimized solutions can then be utilized to provide for image deblocking with respect to the selected section.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can determine an optimal solution in connection with image deblocking.

FIG. 2 illustrates a block diagram of a system that illustrates aspects of acquisition component in further detail.

FIG. 3 depicts a block diagram of a system that can determine convex quantization constraint functions.

FIG. 4 illustrates a block diagram of a system that can determine convex boundary constraint functions.

FIG. 5 is block diagram of a system that can determine an objective function and/or facilitate image deblocking for a decoded image.

FIG. 6 illustrates an exemplary flow chart of procedures that define a method for solving convex optimization for facilitating image deblocking for a decoded image.

FIG. 7 depicts an exemplary flow chart of procedures defining a method for providing additional features in connection with constructing the set of convex constraint functions.

FIG. 8 is an exemplary flow chart of procedures defining a method for providing additional features in connection with constructing the convex objective function.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As used herein, the term “deblocking” generally refers to suppressing, mitigating, and/or removing blocking artifacts found in a decoded image. Deblocking can further refer to the above process while maintaining true object edges (e.g., those edges in the original and/or non-encoded image) and substantially avoiding blurring of the image.

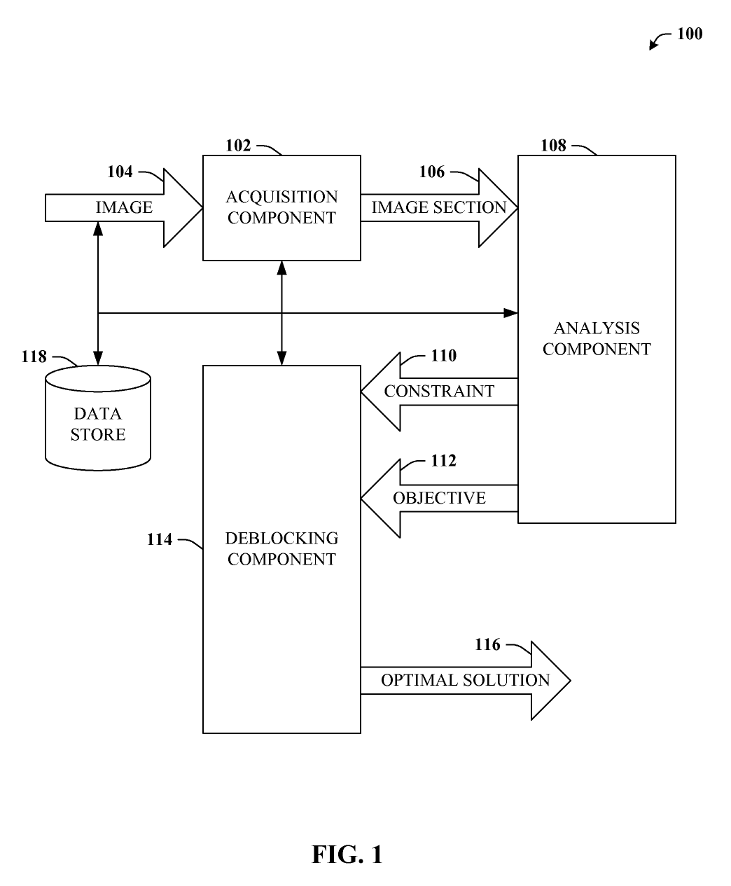

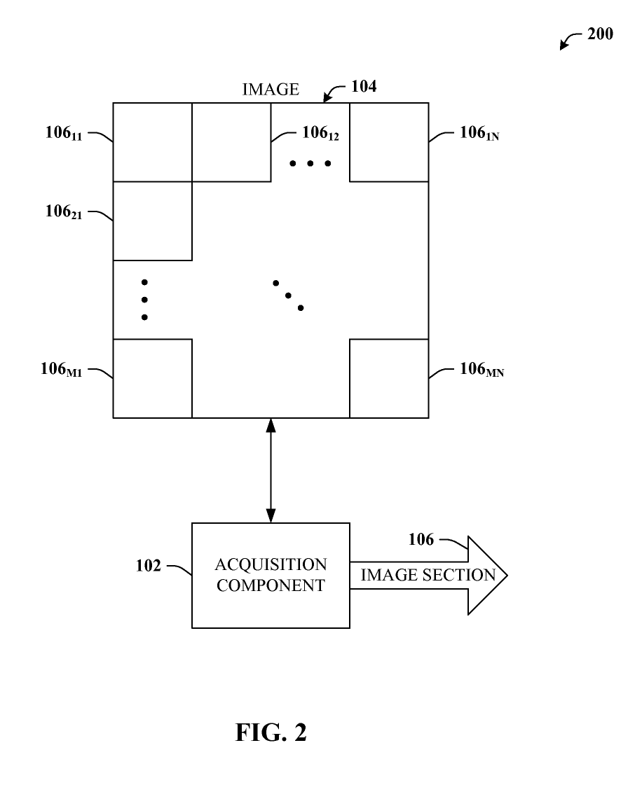

Referring now to the drawings, with reference initially to FIG. 1, system 100 that can determine an optimal solution in connection with image deblocking is depicted. Generally, system 100 can include acquisition component 102 that can receive and/or acquire information (e.g. a data structure) associated with an image such as image 104. Image 104 can represent an encoded bitstream for an image that has been encoded and/or compressed according to substantially any encoding/compression algorithm, format, standard, codec, or the like, including, for example, Joint Photographic Experts Group (JPEG), Tagged Image File Format (TIFF), Graphics Interchange Format (GIF), and so on. In other aspects, image 104 can be a decoded image that was initially encoded according to substantially any encoding process or method, and then subsequently decoded back to the associated file format. In addition, acquisition component can select image section 106 of image 104. Image section 106 can represent a portion of image 104 and is further detailed infra in connection with FIG. 2.

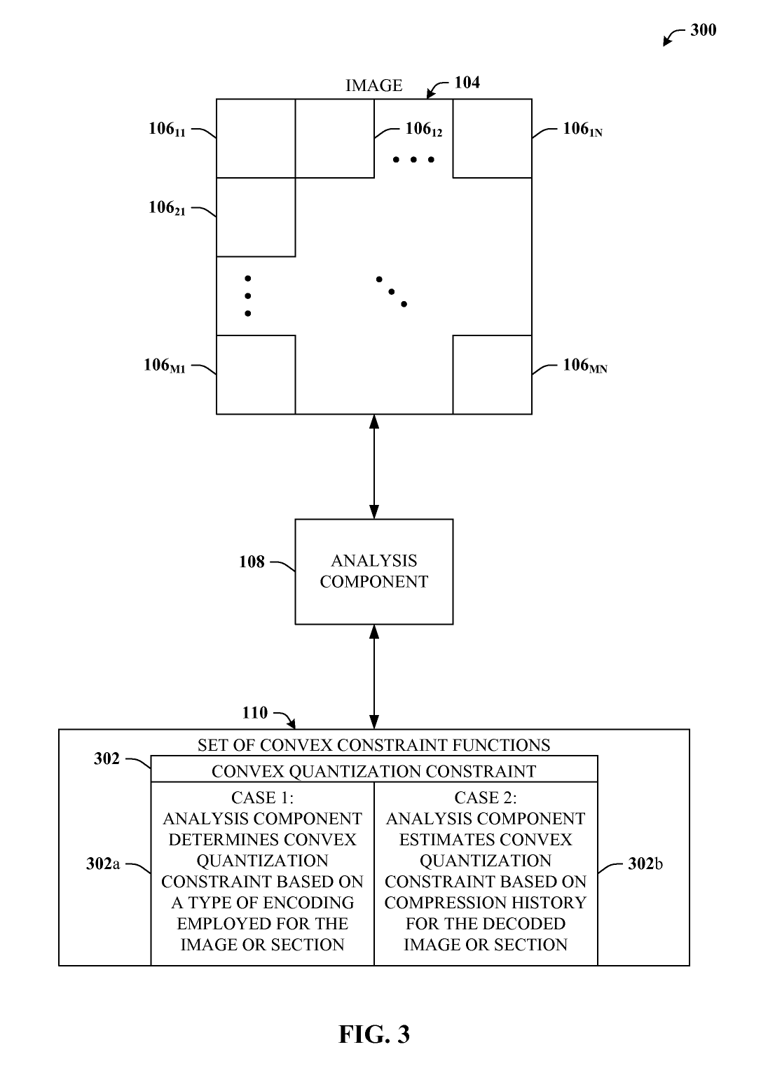

System 100 can also include analysis component 108 that can receive image section 106 (and/or image 104) and can perform various examination procedures on the received data in order to facilitate or aid in construction of certain mechanisms that can be employed to facilitate deblocking. In particular, analysis component 108 can generate set 110 of constraint functions and objective function 112, potentially based upon the examination of image section 106. It should be appreciated that all constraint functions included in set 110 as well as objective function 112 can be convex functions in order to facilitate a convex optimization approach to deblocking. Further detail in connection with analysis component 108 can be found with reference to FIGS. 3-5 infra.

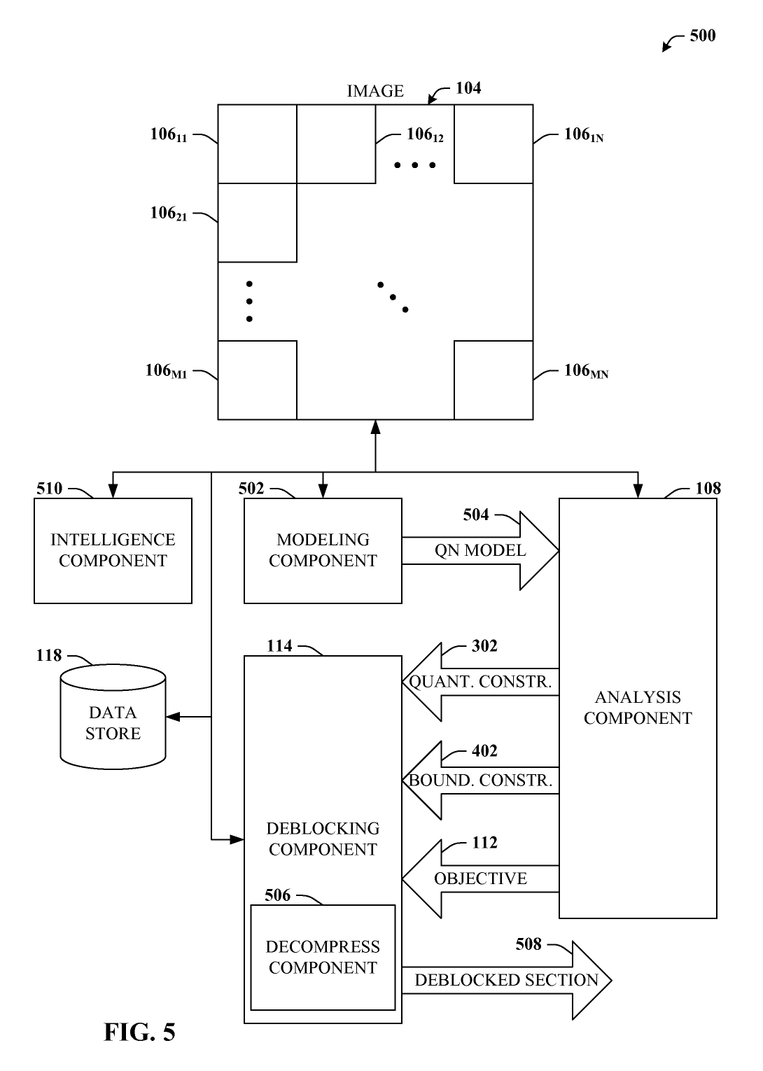

Still further yet, system 100 can include deblocking component 114 that can receive set 110 of convex constraint functions and convex objective function 112, e.g., from analysis component 108. Deblocking component 114 can determine optimal solution 116 to objective function 112 for image section 106, wherein the optimal solution 116 satisfies each constraint function from set 110. In other words, deblocking component 114 can solve objective function 112 with respect to image section 106. Hence, optimal solution 116 can be consistent with all convex constraints included in set 110 and can be utilized for deblocking image section 106 of image 104. Additional features with respect to deblocking component can be found with reference to FIG. 5.

System 100 can also include data store 118, which is intended to be a repository of all or portions of data, data sets, or information described herein or otherwise suitable for use with the claimed subject matter. Data store 118 can be centralized, either remotely or locally cached, or distributed, potentially across multiple devices and/or schemas. Furthermore, data store 118 can be embodied as substantially any type of memory, including but not limited to volatile or non-volatile, sequential access, structured access, or random access and so on. It should be understood that all or portions of data store 118 can be included in system 100, or can reside in part or entirely remotely from system 100.

In accordance with the foregoing, it is readily apparent that the subject matter claimed and described herein can facilitate image deblocking by, e.g. formulating the result in terms of convex optimization. It should be appreciated that a convex optimization problem generally includes optimization variables, an objective function to be minimized, and a number of constraint functions. Thus, the formalization described herein can utilize image section 106 (e.g., pixels included in image section 106) as the optimization variables, or the area or region of image 104 that is to be optimized. Naturally, the objective function can be objective function 112, while the constraint functions can be represented by set 110 of constraint functions. All constraint functions from set 110 as well as objective function 112 can be convex functions. Furthermore, in some cases, one or more functions can be further restricted to be linear. The optimization process can be directed to finding the optimal values of optimization variables (e.g. image section 106) such that objective function 112 can be minimized while all the constraints are satisfied.

In particular, based on analysis of certain features associated with an input image (e.g., image 104) such as, e.g., a type of compression employed as well as a complexity of the region being processed (e.g., smooth versus textured), a set of convex constraint functions (e.g., set 110) for a deblocked image can be constructed. Furthermore, an objective function potentially based on maximum-likelihood estimation (e.g., objective function 112) can also be constructed with respect to the region being processed (e.g., image section 106). Given the described constraint functions and objective function, image deblocking can be formulated as a convex optimization problem, which can be readily solved using numerical methods, and the final output image or section can be guaranteed to be the optimal one for the given objective function while satisfying all the constraints. Thus, the claimed subject matter can mitigate blocking artifacts, yet can substantially preserve image edges. Moreover, while the subject matter described herein can be applied in a very general manner, more sophisticated convex constraints, potentially including constraints already known in the art can be utilized in connection with the claimed subject matter.

Turning now to FIG. 2, system 200 that illustrates aspects of acquisition component in further detail is illustrated. As noted supra, acquisition component 102 can receive all or a portion of image 104. Acquisition component 102 can select a section of image 104, such as image section 106. In particular, acquisition component 102 can select one or more sections 106 of image 104 denoted herein by row-column subscript, e.g., section 106₁₁-106_{MN}, where M and N are positive integers. Image section 106 is referred to herein, either collectively or individually, as image section(s) 106, with specific subscripts typically utilized only when necessary to prevent confusion or provide more specificity. Generally, image section 106 can be, e.g. an 8 pixel by 8 pixel block of image 104, however, it should be appreciated that other values can be employed. For example, section 106 can be a 4×4 pixel block, a 10×10 pixel block, an 8×16 block, or substantially any suitable size or shape accounting for a portion of image 104. For the sake of clarity and brevity, an 8×8 block is used in the remainder of the description, and this image section 106 can represent the optimization variable of the current convex optimization problem, which is denoted herein as X.

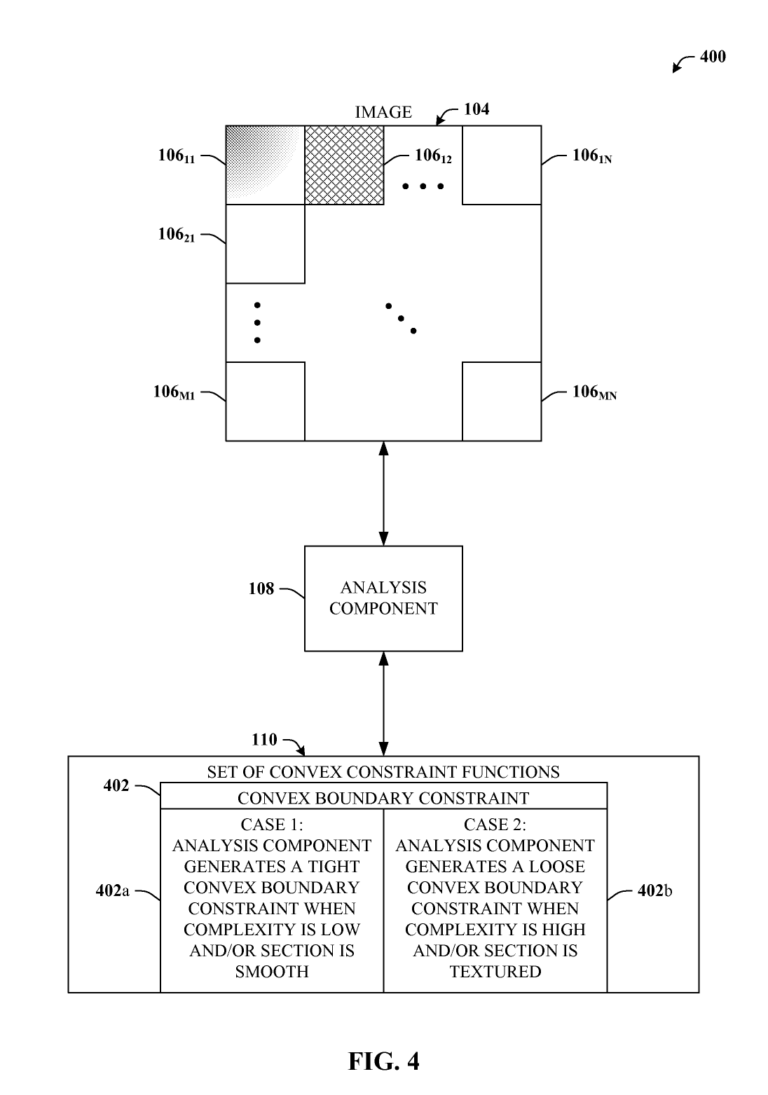

With reference now to FIG. 3, system 300 that can determine convex quantization constraint functions is provided. Analysis component 108 can examine image 104 and/or image section 106 selected by acquisition component 102 in order to generate set 110 of convex constraint functions. Set 110 can include quantization constraint functions 302, as depicted, as well as boundary constraint functions (detailed in connection with FIG. 4, infra). Appreciably, analysis component 108 can create quantization constraint functions based upon a type of encoding employed for image 104 and/or image section 106, which can be determined by examination, and is depicted as 302a. Additionally or alternatively, analysis component 108 can estimate a convex quantization constraint function based upon compression history for the decoded image or section, denoted 302b.

To provide additional context, the image coding process is briefly reviewed. Let X_{O} be the input optimization variable (e.g., image section 106). First, DCT transform can be applied to X_{O}, giving rise to DCT block Y_{O},

Y_{O}=H^{T}X_{O}H, (1)

where H and H^{T} are the DCT transform matrix and its transpose, respectively.

Subsequently, the DCT matrix Y_{O} is quantized. The quantization process typically is not part of the coding standard, and thus can be user-defined. Accordingly, in order to provide a concrete illustration, a widely-used quantization process is assumed. However, it should be appreciated that the claimed subject matter can be useful for other quantization processes or standards. Let Y_{O}(i,j) be the (i,j)-th coefficient of Y_{O}. The quantization process of Y_{O}(i,j) can be described using the following equation:

$${Y}_{q} ( i , j ) = sign ( {Y}_{O} ( i , j ) ) \cdot ⌊ \frac{\vert {Y}_{O} ( i , j ) \vert}{α \cdot Q ( i , j )} + 0.5 ⌋ , \qquad ( 2 )$$

where Yq(i,j) is the quantized value of Y_{O}(i,j), α is the quantization parameter (qp), Q(i,j) is the (i,j)-th coefficient of quantization factor matrix Q, notation └·┘ denotes the maximum integer less than or equal to the argument, and sign(y) is the sign function equal to 1 when y>0; 0 when y=0; and −1 when y<0.

At the decoder side, Y_{q}(i,j), α, and Q(i,j) can be obtained from the bitstream, e.g., in case 1 for convex quantization constraint function 302a. For situations in which the decoding process is not accessible, the convex quantization constraint function 302b (e.g., case 2) can be estimated from the decoded image based upon well-known compression history estimation techniques. Given Y_{q}(i, j), α, and Q(i,j), the maximum and minimum possible values of Y_{O}(i,j) can be determined. In accordance therewith, matrices U (e.g. upper) and L (e.g., lower), whose elements U(i,j) and L(i,j) can be the maximum and minimum possible values of Y_{O}(i,j), respectively. The expressions of U(i,j) and L(i,j) can be as follows:

U(i,j)=α·Q(i,j)·(Y_{q}(i,j)+0.5); (3)

L(i,j)=α·Q(i,j)·(Y_{q}(i,j)−0.5). (4)

According to the described deblocking approaches, it can be desirable to restore the original blocking-free image X_{O}. For image sections 106 whose DCT coefficients lie outside the range [L, U], it is highly probable those image sections 106 are quite different from the original block X_{O}. As a result, the following quantization constraint is defined for the optimization variable X_{O} (e.g. the current image section 106 being processed):

L [symbol] H^{T}XH [symbol] U, (5)

where [symbol] denotes element-wise inequality. It is therefore readily apparent that constraint function H^{T}XH is linear and thus convex.

Referring now to FIG. 4, system 400 that can determine convex boundary constraint functions is depicted. As with the description of FIG. 3, analysis component can examine image section 106 in order to construct one or more constraint functions included in set 110. In this example illustration, analysis component 108 can create one or more convex boundary constraint function 402. In particular, analysis component 108 can generate a convex boundary constraint function based upon a complexity of image section 106. For example, analysis component 108 can create a tight boundary constraint function 402a when the complexity of image section 106 is low (e.g., non-complex or smooth section). Additionally or alternatively, analysis component 108 can construct a loose boundary constraint function when the complexity of image section 106 is high (e.g., textured).

Thus, with reference to image section 106₁₁, that particular portion of image 104 can be seen to be rather smooth. In contrast, image section 106₁₂ appears to be highly textured. Accordingly, analysis component 108 can generate a tight convex boundary constraint function 402a for image section 106₁₁, yet generate a loose convex boundary constraint function 402b for image section 106₁₂.

Initially, the horizontal gradient and vertical gradient of X can be defined. Let Xᵣ and X_{b} be the right and the bottom blocks of X. For X(i,j), the horizontal gradient, Gₕ(i,j), and vertical gradient, Gᵥ(i,j), can be calculated as follows:

$$\begin{matrix}{G}_{h} ( i , j ) = \{ \begin{matrix}\vert X ( i , j ) - X ( i + 1 , j ) \vert , & i = 0 … 6 ; \\ \vert X ( 7 , j ) - {X}_{r} ( 0 , j ) \vert , & otherwise .\end{matrix} & ( 6 ) \\ {G}_{v} ( i , j ) = \{ \begin{matrix}\vert X ( i , j ) - X ( i , j + 1 ) \vert , & i = 0 … 6 ; \\ \vert {X}_{b} ( i , 0 ) - X ( i , j ) \vert , & otherwise .\end{matrix} & ( 7 )\end{matrix}$$

Appreciably, both i and j operate from 0 to 7 given image section 108 was defined to be an 8×8 block of pixels. Other values for i and j could understandably be employed for differently sized image sections 106. It should also be appreciated that natural images (e.g., normal input image 104) tend to be substantially smooth. However, for sections of the image that include blocking artifacts, there typically are numerous “false edges” at the section boundaries, and thus the gradients of pixels included in image section 106 located at section boundaries can be very large. Accordingly, constraints on the gradients of boundary pixels can be established in order to ensure the smoothness across the various sections.

According to an aspect, the proposed approach can process the image sections 106₁₁-106_{MN} in a left-to-right and top-to-bottom order. Hence, when the current section is to be processed, the upper and left neighboring sections generally have already been processed. Accordingly, it can be assumed that blocking artifacts at the left and upper boundaries have been previously handled or suppressed. Therefore, essentially only the gradients at the right and bottom boundaries need be constrained.

The following constraints to the cross-boundary differences can be applied.

Gₕ(7,j)≦ζₕ, j=0, . . . , 7; (8)

Gᵥ(i,7)≦ζᵥ, i=0, . . . , 7; (9)

where ζₕ and ζᵥ are, respectively, horizontal and vertical thresholds explained in greater detail infra. For equations denoted (8) and (9), Gₕ(j) and Gᵥ(i) are norm functions, and are thus convex.

The boundary constraints can be utilized in order to suppress extant blocking artifacts by forcing the cross-boundary difference below the given thresholds, ζₕ and ζᵥ. Moreover, generally, for different parts of the image, the spatial complexity is different and the visibility of the blocking artifact is different as well. Specifically, the blocking artifacts are often more visible in smooth regions such as image section 106₁₁, and less perceptible in textured regions such as image section 106₁₂. So, while the constraints for the smooth regions (e.g., low complexity) will usually be constructed to be very tight, the constraint can be loosened in the textured regions (e.g., high complexity) so that more freedom can be given to the optimization without noticeably affecting visual quality. Thus, the values of ζₕ and ζᵥ can be adaptive to the spatial complexity of the current image section 106.

If the original section is not available, the spatial complexity can be estimated using the decoded blocking section X_{q}. The smooth regions should have relatively small gradient while textured regions should have relatively large gradient. Thus, the gradient information of X_{q} can be used to measure the spatial complexity. The horizontal gradient and vertical gradient of the blocking section X_{q} can thus be calculated. To overcome the effects of a false edge at boundaries, the horizontal gradients of the pixels at the right boundary, and the vertical gradients of the pixels at the bottom boundary, need not be considered. Let τₕ and τᵥ be the maximum horizontal and vertical gradient in X_{q}, the thresholds ζₕ and ζᵥ can be calculated as follows,

ζₕ=τₕ+cₕ; (10)

ζᵥ=τᵥ+cᵥ, (11)

where cₕ and cᵥ are horizontal and vertical offsets, respectively, that can be predetermined, intelligently determined, determined ad hoc, or defined by a user.

Turning now to FIG. 5, system 500 that can determine an objective function and/or facilitate image deblocking for a decoded image is depicted. Although not depicted, system 500 can include acquisition component 102 that can receive at least a portion of image 104 and can select image section 106 for processing as detailed supra. Likewise, system 500 can include analysis component 108 that can examine image section 106 in order to construct set 110 of convex constraint functions, namely, one or more quantization constraint function 302 and one or more boundary constraint function 402, as detailed supra in connection with FIGS. 3 and 4, respectively. In addition, analysis component 108 can generate convex objective function 112, which can now be described in more detail.

In an aspect of the claimed subject matter, objective function 112 can be a likelihood function of X. More particular, objective function 112 can include a logarithm-likelihood portion and a summation portion that sums horizontal and vertical gradients over image section 106. In order to derive the likelihood function of X, a quantization noise model for image section 106 can be constructed. In accordance therewith, system 500 can further include modeling component 502 that can construct quantization noise model 504, which can be provided to analysis component 108. In an aspect of the claimed subject matter, analysis component 108 can derive objective function 112 based upon an examination of quantization error variance included in quantization noise model 504, an example of such is provided infra.

To begin, one can define quantization error block, E, whose (i,j)-th element, E(i,j), is the quantization error in X_{q}(i,j),

E(i,j)=X_{O}(i,j)−X_{q}(i,j). (12)

Although not strictly necessary, assumptions can be adopted that quantization errors E(i,j) follow Gaussian distribution and are mutually independent. Hence,

$${p}_{E} ( E ( i , j ) ) = \frac{1}{\sqrt{2 π} {σ}_{E} ( i , j )} exp ( - \frac{{E}^{2} ( i , j )}{2 {σ}_{E}^{2} ( i , j )} ) , \qquad ( 13 )$$

where σ_{E}²(i,j) is the variance of quantization error.

It should be appreciated that while previous works associated with image deblocking made the assumptions that quantization errors follow Gaussian distribution and are mutually independent, such works also assumed that the quantization error at different locations within the image portion being process have the same variance. However, simulation results suggest otherwise. For example, quantization error variance approximated using mean squared pixel error for a typical image section 106 indicates that quantization error variance is relatively small for central pixels, and relatively large for pixels along edges of image section 106. In other words, given an 8×8 image section 106, a central block of pixels X(i,j), where both i and j range from 1 to 6, the central block yields very small error variance. However, around the edges (e.g., i or j=0 or 7), the error variance increases, often quite dramatically so.

Thus, construction of objective function 112 in accordance with an aspect of the claimed subject matter can be based upon quite unexpected results. Namely, an understanding that is quite contrary to conventional thought that error variance is largely the same across the entire region or image section being processed. In deference to this new insight, the following function can be utilized to approximate the shape of σ_{E}²(i,j):

σ_{E}²(i,j)=a·((i−3.5)²+(j−3.5)²+d), (14)

where a is a factor increasing with α and d is a constant.

As the final X should be as similar to Xₒ as possible, the likelihood of X given X_{q} is assumed to be as the same as that of Xₒ,

$$p ( X ( i , j ) \vert {X}_{q} ( i , j ) ) = \frac{1}{\sqrt{2 π} {σ}_{E} ( i , j )} exp ( - \frac{{( X ( i , j ) - {X}_{q} ( i , j ) )}^{2}}{2 {σ}_{E}^{2} ( i , j )} ) . \qquad ( 15 )$$

The likelihood functions of X(i,j) can be assumed to be independent, and the following log-likelihood function for optimization variable X can be derived as:

$$\begin{matrix}log p ( X \vert {X}_{q} ) = log {\prod }_{i , j = 0}^{7} p ( X ( i , j ) \vert {X}_{q} ( i , j ) ) \\ = C - {\sum }_{i , j = 0}^{7} \frac{{( X ( i , j ) - {X}_{q} ( i , j ) )}^{2}}{2 {σ}_{E}^{2} ( i , j )} ,\end{matrix} \\ where C = - {\sum }_{i , j = 0}^{7} log \sqrt{2 π} {σ}_{E} ( i , j ) \qquad ( 16 )$$

It is also desirable that X be smooth and thus gradient Gₕ(i,j) and Gᵥ(i,j) can also be included in objective function 112 for minimization. Objective function 112 can be a combination of the log-likelihood function and the gradients,

$$f ( X ) = - log p ( X \vert {X}_{q} ) + λ {\sum }_{i , j = 0}^{7} ( {G}_{h}^{2} ( i , j ) + {G}_{v}^{2} ( i , j ) ) , \qquad ( 17 )$$

where λ can be a user-defined weight factor. From equations (16) and (17), it is readily apparent that objective function 112 is a linear combination of convex functions and therefore is also convex.

Based upon the foregoing, the convex optimization problem for image blocking can be formulated as:

$$min - log p ( X \vert {X}_{q} ) + λ {\sum }_{i , j = 0}^{7} ( {G}_{h}^{2} ( i , j ) + {G}_{v}^{2} ( i , j ) ) , \\ s . t . \\ {G}_{h} ( 7 , j ) \leq {ζ}_{h} \\ {G}_{v} ( i , 7 ) \leq {ζ}_{v} \\ L {H}^{T} XH U . \qquad ( 18 )$$

The convex optimization problem can be easily solved, for example by employing well-known and readily available scientific software named. It is possible that in some cases, the convex optimization problem is infeasible, meaning that no X can simultaneously satisfy quantization constraints and boundary constraints. Typically such a situation will arise when there is a “true edge” at the boundary of the current block. In such case, it should be appreciated that the deblocking processes described herein need not be performed. Thus, a true edge, we will not be blurred in any way.

In accordance with the foregoing, analysis component 108 can thus supply one or more convex quantization constraint function 302, one or more convex boundary constraint function 402, and objective function 112 to deblocking component 114. As detailed supra, deblocking component 114 can determine optimal solution 116 to objective function 112 for image section 106, wherein optimal solution 116 can satisfy each constraint function 302, 402 from set 110 of convex constraint functions. Based upon optimal solution 116 for image section 106, deblocking component 114 can produce deblocked section 508 for image section 106, where deblocked section 508 is substantially free of blocking artifacts, yet retains edges.

It was further noted above that image 104 (and therefore image section 106) can be an encoded bitstream/bytestream or exist as a decoded image in the associated encoding file format. It should therefore be understood that in the cases where image 104 is encoded, deblocking component 114 can include or be operatively coupled to decoding component 506 that can decode and/or decompress the encoded bitstream into the associated file format. Although not expressly depicted, in some implementations, decoding component 506 can be included in or operatively coupled to acquisition component 102. In the latter situation, acquisition component 106 can facilitate decoding of an encoded bitstream prior to selection of image section 106.

In addition, system 500 can further include intelligence component 510 that can provide for or aid in various inferences or determinations. It is to be appreciated that intelligence component 510 can be operatively coupled to all or some of the aforementioned components. Additionally or alternatively, all or portions of intelligence component 510 can be included in one or more of the components described herein. Moreover, intelligence component 510 will typically have access to all or portions of data sets described herein, such as data store 118, and can furthermore utilize previously determined or inferred data.

Accordingly, in order to provide for or aid in the numerous inferences described herein, intelligence component 510 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

More particularly, intelligence component 510 can be employed or accessed by analysis component 108 in order to intelligently estimate parameters for quantization constraint function 302 in cases where the decoding process is not available. As another example, intelligence component 510 can provide machine learning techniques to aid or enhance generation of boundary constraint functions 402 based upon complexity analysis. In other situations, intelligence component 510 can be utilized by deblocking component 114 in order to construct optimized solution 116, again potentially based upon machine learning techniques.

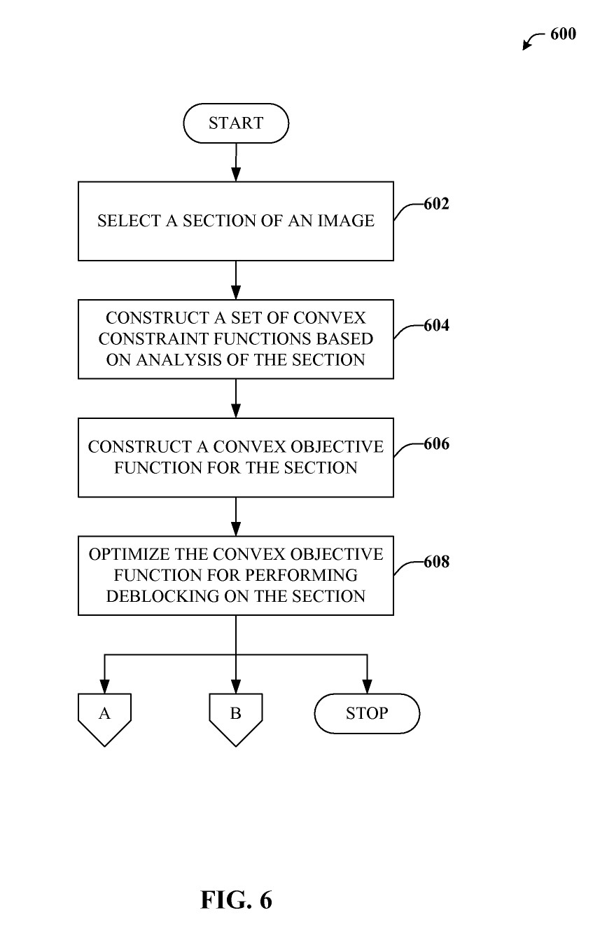

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 6, exemplary method 600 for solving convex optimization for facilitating image deblocking for a decoded image is illustrated. Generally, at reference numeral 602, a section of an image can be selected. It should be understood that the selected section can be any suitable dimensions in terms of pixels. Moreover, the pixels included in the selected section of the image can represent the optimization variables for the convex optimization.

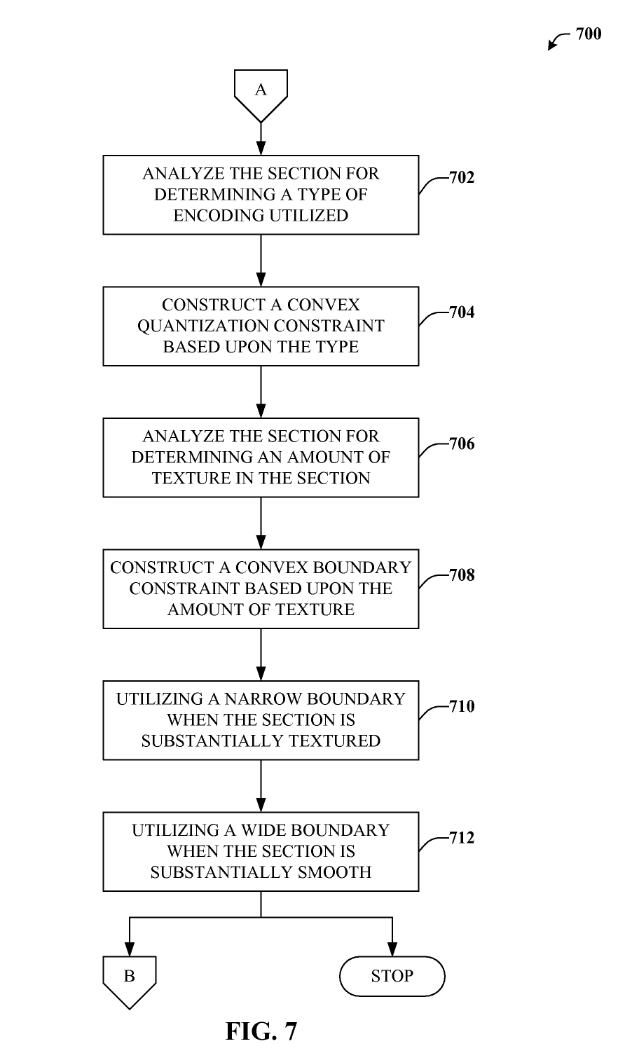

At reference numeral 604, a set of convex constraint functions can be constructed based upon an analysis of the selected section, for which addition details or features are described in connection with FIG. 7. Next to be described, at reference numeral 606, a convex objective function can be constructed for the selected section, for which additional details or features are also further described with reference to FIG. 7. It should be understood that certain functions included in the set of convex constraint function can be linear functions as well as convex functions.

At reference numeral 608, the convex objective function can be optimized. Typically, the optimization can be carried out based upon numerical methods that are readily accessible. In addition, the optimization of the convex objective function can require that each and every convex constraint function composing the set of convex constraint functions be satisfied.

Referring to FIG. 7, exemplary method 700 for providing additional features in connection with constructing the set of convex constraint functions is depicted. Initially, at reference numeral 702, the section selected at act 602 of FIG. 6 can be analyzed for determining a type of encoding utilized. In cases in which the type is readily available, at reference numeral 704, a convex quantization constraint function can be constructed based upon the type of encoding utilized. However, in other cases such as when the type of encoding employed is not readily available, then the decoded image for the selected section can be analyzed for determining or inferring the parameters of the quantization constraint function. Appreciably, the convex quantization constraint function can be included in the set of convex constraint function detailed at act 604.

At reference numeral 706, the selected section can be analyzed for determining an amount of texture in the selected section. Based upon the amount of texture (e.g., very smooth to highly textured) identified in the selected section, at reference numeral 708, a convex boundary constraint function can be constructed. In more detail, a narrow boundary for the convex boundary constraint function can be utilized when the selected section is substantially textured as indicated at reference numeral 710. In contrast, when the selected section is substantially smooth, a wide boundary for the convex boundary constraint function can be utilized as denoted at reference numeral 712. Again, it is to be understood that the convex boundary constraint functions can be included in the set of convex constraint functions described in connection with act 604

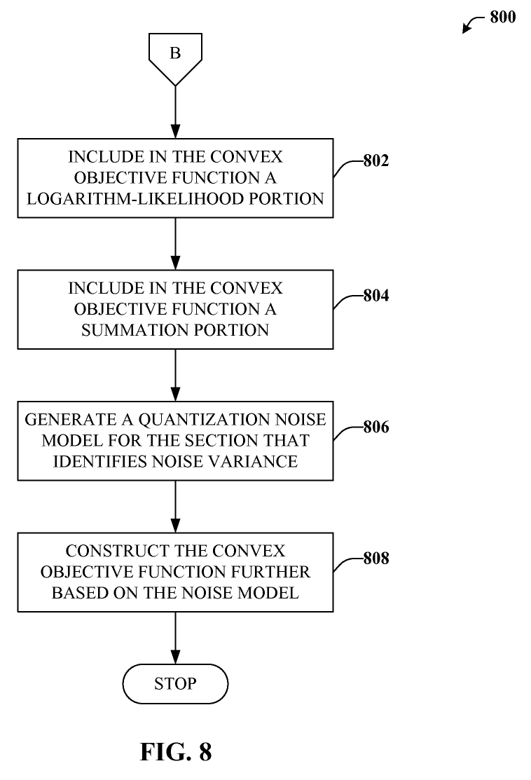

With reference now to FIG. 8, method 800 for providing additional features in connection with constructing the convex objective function is illustrated. In general, at reference numeral 802, a logarithm-likelihood portion or component can be included in the convex objective function. Evolutionary examples of the logarithm-likelihood component can be found supra with reference to equations (16)-(18) and the associated text. Likewise, a summation component or portion that sums gradients over the selected section can also be included in the convex objective function, wherein one example is provided in equations (17) and (18).

At reference numeral 806, a quantization noise model can be generated for the selected section. The quantization noise model can depict or define quantization error variance for pixels included in the selected sections. The quantization error variance can be defined as mean squared pixel error variance. At reference numeral 808, the convex objective function can be constructed further based upon the quantization noise model generated at act 806.

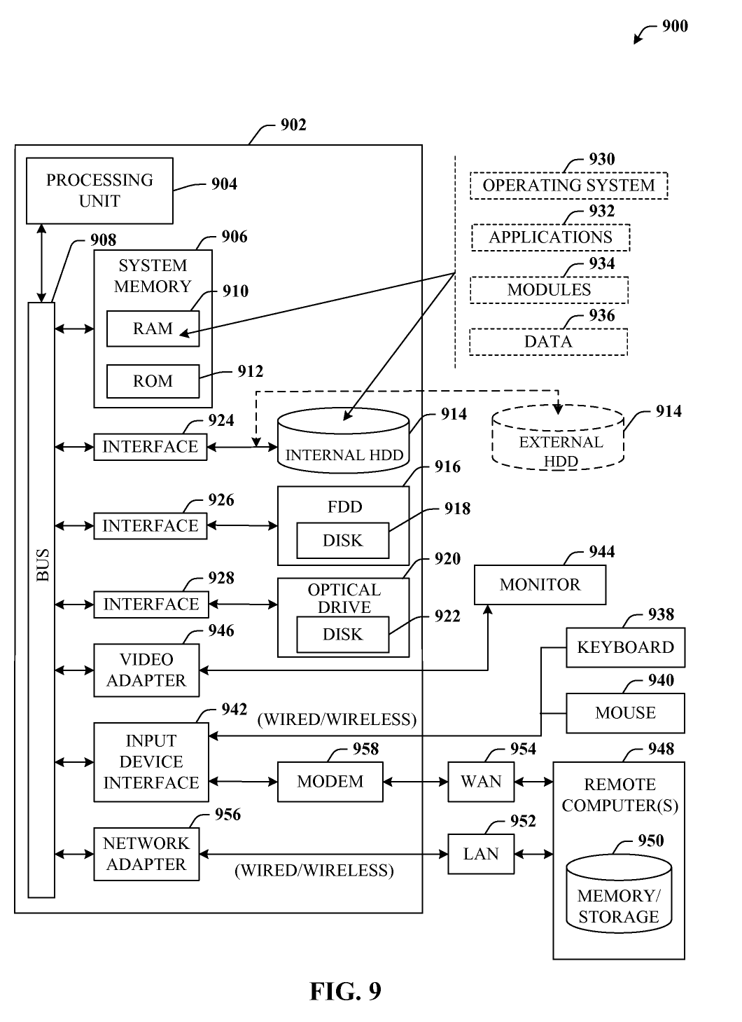

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 9 Mbps (802.11b) or 54 Mbps (802.11a) data rate, for example, or with products that contain both bands (dual band), so the networks can provide real-world performance similar to the basic “10BaseT” wired Ethernet networks used in many offices.

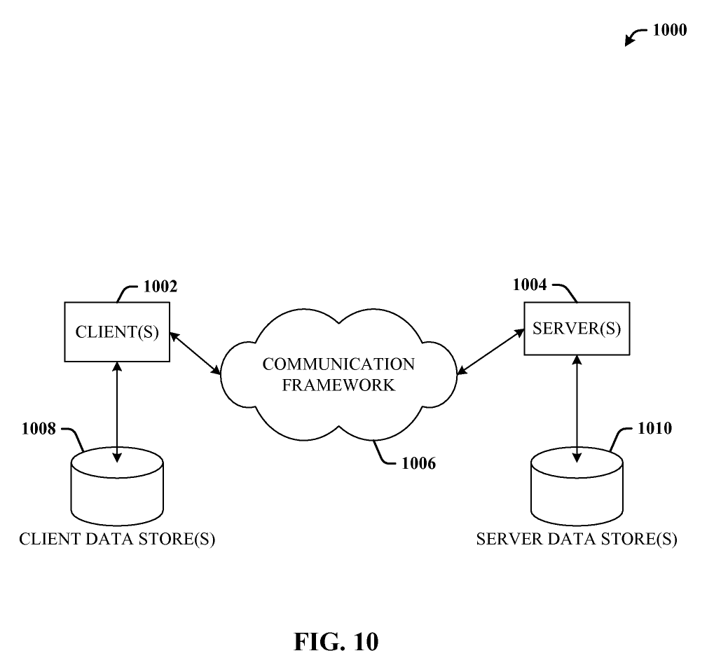

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g. threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates image deblocking for a decoded image, comprising:
an acquisition component that receives at least a portion of an image and that selects a section of the image;
an analysis component that examines the section and that generates a set of constraint functions and an objective function, the objective function and each constraint function from the set are convex functions; and
a deblocking component that determines an optimal solution to the objective function for the section, the optimal solution satisfies each constraint function from the set in order to facilitate deblocking of the section.

2. The system of claim 1, the set of constraint functions includes a convex quantization constraint function.

3. The system of claim 2, the analysis component generates the quantization constraint function based upon a type of encoding employed for the image.

4. The system of claim 2, the analysis component estimates parameters for the quantization constraint function based upon analysis of the image or the section.

5. The system of claim 1, the set of constraint functions includes a convex boundary constraint function.

6. The system of claim 5, the analysis component determines the boundary constraint function based upon a complexity of the section.

7. The system of claim 6, the analysis component generates a tight boundary constraint function when the complexity of the section is low.

8. The system of claim 6, the analysis component generates a loose boundary constraint function when the complexity of the section is high.

9. The system of claim 1, the objective function includes a logarithm-likelihood portion and a summation portion that sums horizontal and vertical gradients over the section.

10. The system of claim 1, further comprising a modeling component that constructs a quantization noise model for the section.

11. The system of claim 10, the analysis component derives the objective function based upon an examination of quantization error variance included in the quantization noise model.

12. A method for facilitating image deblocking for a decoded image, comprising:
selecting a section of an image;
constructing a set of convex constraint functions based upon an analysis of the section;
constructing a convex objective function for the section; and
optimizing the convex objective function while satisfying each convex constraint function from the set for performing deblocking on the section.

13. The method of claim 12, further comprising analyzing the section for determining a type of encoding utilized.

14. The method of claim 13, further comprising constructing a convex quantization constraint function based upon the type of encoding utilized and including the convex quantization constraint function in the set of convex constraint functions.

15. The method of claim 12, further comprising analyzing the section for determining an amount of texture in the section.

16. The method of claim 15, further comprising constructing a convex boundary constraint function based upon the amount of texture in the section and including the convex quantization constraint function in the set of convex constraint functions.

17. The method of claim 16, further comprising utilizing a narrow boundary for the convex boundary constraint function when the section is substantially textured.

18. The method of claim 16, further comprising utilizing a wide boundary for the convex boundary constraint function when the section is substantially smooth.

19. The method of claim 12, further comprising at least one of the following acts:
including in the convex objective function a logarithm-likelihood portion;
including in the convex objective function a summation portion that sums gradients over the section;
generating a quantization noise model for the section; or
constructing the convex objective function further based upon the quantization noise model.

20. A system for facilitating image deblocking for a decoded image, comprising:
means for choosing a portion of an image;
means for creating one or more convex quantization constraint function associated with the portion;
means for creating one or more convex boundary constraint function associated with the portion;
means for creating a convex objective function associated with the portion; and
means for optimally solving the convex objective function for the portion while satisfying each convex quantization constraint function and each boundary constraint function.
